(19) United States
(12) Patent Application Publication
(10) Pub. No.: US 2017/0337612 A1
(43) Pub. Date: Nov. 23, 2017

(54) REAL-TIME RECOMMENDATION OF ENTITIES BY PROJECTION AND COMPARISON IN VECTOR SPACES

(71) Applicant: eBay Inc., San Jose, CA (US)

(72) Inventors: Daniel Galron, San Jose, CA (US); Siming Li, San Jose, CA (US); Krutika Shetty, New York, NY (US)

(21) Appl. No.: 15/162,129

(22) Filed: May 23, 2016

(51) Int. Cl. G06Q 30/06

(52) U.S. Cl. CPC G06Q 30/0631; G06Q 30/0641

(57) ABSTRACT

A system and method to evaluate the affinity of a collection of sale items to a user's interests. The affinity is a measure of how closely a user's interests match the contents of a collection (e.g., a collection of items selected by a seller, other user, or employee of the sales site). The method may determine the affinity of various collections by using a vector-space distance measure between the user's categories of interest and the relative percentages of various categories of items in each collection's. The method may also add a quality score for the collection to the affinity score and/or a random value to ensure that the system recommends high quality collections does not recommend the same set of collections every time the user logs in or visits the sales site.

### TECHNICAL FIELD

Embodiments of the present disclosure relate generally to providing real-time recommendations of collections on an online sales site to individual users based on each individual user's past viewed items, watched items, bid upon items, and/or purchased items.

### BACKGROUND

Items of a staggering array of different types are placed on and removed from online sales sites (e.g., online auction sites) as sellers put the items up for sale and buyers buy the items. A particular buyer will only be interested in a subset of categories of items. Some auction sites allow sellers (and in some cases other users) to group related sets of items that include multiple categories of items into collections of items. For example, a collection of items may include items indicating support for a particular sports team. Items in that collection may come from the categories of food service items (e.g., commemorative mugs), automotive items (e.g., bumper stickers with a team logo), clothing (e.g., hats with the team logo) and so on.

Since prospective buyers are shopping online and may have hundreds of thousands of items to choose from, problems arise from the networked nature of the shopping that do not occur in traditional bricks and mortar stores. For example, in a bricks and mortar store, a merchant concentrates on a relatively small number of goods in a particular department and will not be able to tailor recommendations to an individual customer.

In the online shopping experience, it is both possible and desirable to present the prospective buyers with recommended collections that fit his interests in real-time (e.g., within a few seconds of the user logging onto or viewing the online sales site). In order to focus on the individual interests of a particular customer, collections must be recommended far too rapidly for any human being to individually evaluate which collections are likely to be of interest to a particular user. Accordingly, there is a need in the art for an automated method of evaluating collections that involve far too many items and variables for a human to evaluate in real-time.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 conceptually illustrates a method of some embodiments for selecting, in real-time, collections of items for sale to present to a user.

FIG. 3A conceptually illustrates a graph of an example set of different levels of interest by a single user as indicated by categories of viewed items and categories of watched items.

FIG. 3B conceptually illustrates a graph of an example set of different percentages of various categories of items in a particular collection.

FIG. 4A conceptually illustrates ranking of collections of items with various dominant categories.

FIG. 4B conceptually illustrates the selection of collections for display.

FIG. 5 illustrates the flow of data within an example system for implementing the selection of collections to display to a user.

FIG. 6 is a block diagram illustrating an example of a software architecture that may be installed on a machine, according to some example embodiments.

FIG. 7 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Some embodiments evaluate the affinity of a collection to a user's interests. The affinity is a measure of how closely a user's interests match the contents of a collection (e.g., a collection of items selected by a seller, other user, or employee of the sales site). The method may determine the affinity of various collections by using a vector-space distance measure between the user's categories of interest and the relative percentages of various categories of items in each collection's. The method may also add a quality score for the collection to the affinity score and/or a random value to ensure that the system does not recommend the same set of collections every time the user logs in or visits the sales site.

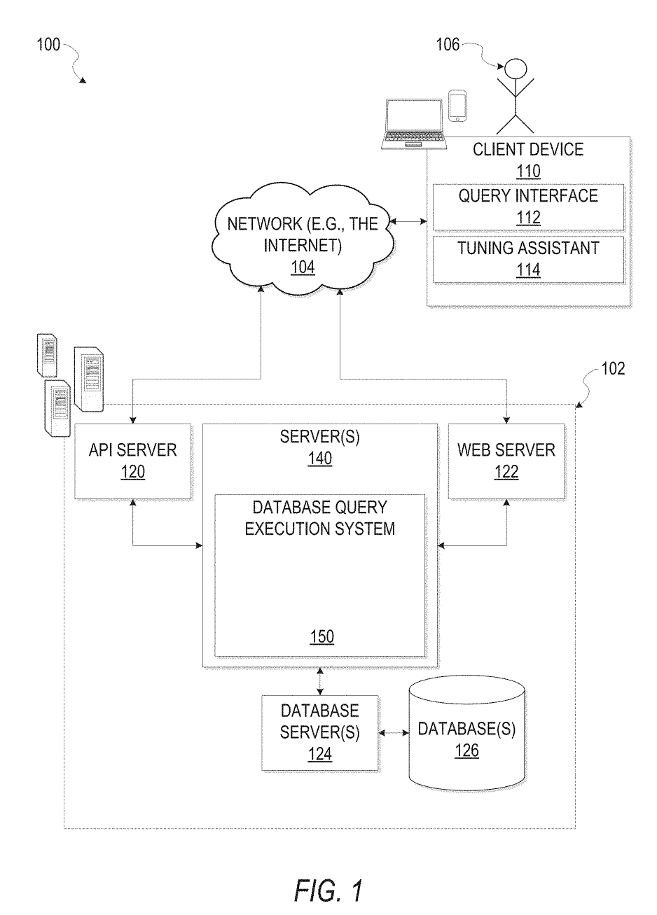

The system of some embodiments uses various databases to track the user's (buyer's) interests by tracking items that the user views, watches, bids on (in auctions) and/or purchases. With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a database query interface 112, a database tuning assistant 114, and a programmatic client 116 executing on client device 110.

The client device 110 may comprise, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. One or more users 106 may be a person, a machine, or other means of interacting with client device 110. In embodiments, the user 106 is not part of the network architecture 100, but may interact with the network architecture 100 via client device 110 or another means. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client device 110 may include one or more applications (also referred to as “apps”) such as, but not limited to, a database query interface, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment, etc.). Conversely if an e-commerce site application is not included in the client device 110, the client device 110 may still use its a database query interface 112 to access a database (or a variant thereof) hosted on the server(s) 140.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the server(s) 140 via the network 104. In this instance, the networked system 102, in response to receiving the input from the user, communicates information to the client device 110 via the network 104 to be presented to the user. In this way, the user can interact with the server(s) 140 using the client device 110.

An application program interface (API) server 120 and a web server 122 are coupled to, and provide programmatic and web interfaces respectively to, one or more server(s) 140. The server(s) 140 may host one or more database query execution systems, each of which may comprise one or more modules or applications and each of which may be embodied as hardware, software, firmware, or any combination thereof. The server(s) 140 are, in turn, shown to be coupled to one or more database servers 124 that facilitate access to one or more information storage repositories or database(s) 126. In an example embodiment, the databases 126 are storage devices that store information to be posted (e.g., publications or listings) to a publication system and accessible to database queries provided via database query interface 112. The databases 126 may also store digital item information in accordance with example embodiments.

The database query execution system 150 may provide functionality operable to divide the operations commanded by database queries into multiple parallel operations to be performed by one or more database servers 124 using the queries supplied by users of the database interface 112. In some embodiments, the database query execution system runs on top of a database server (e.g., SQL Server, Oracle, MySQL, Hadoop or other database server). In other embodiments, the database query execution system is part of an execution engine/query plan engine of the database server. In either of such embodiments, the database query execution system 150 may access the searched for data from the databases 126, and other sources.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The database query execution system 150 could also be implemented as standalone software programs, which do not necessarily have networking capabilities.

The database query interface 112 may access the database via the web interface supported by the web server 122. The database tuning assistant 114 may receive recommendations and statistics regarding a set of one or more queries produced via an account (e.g., using database query interfaces 112 on one or more client devices.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

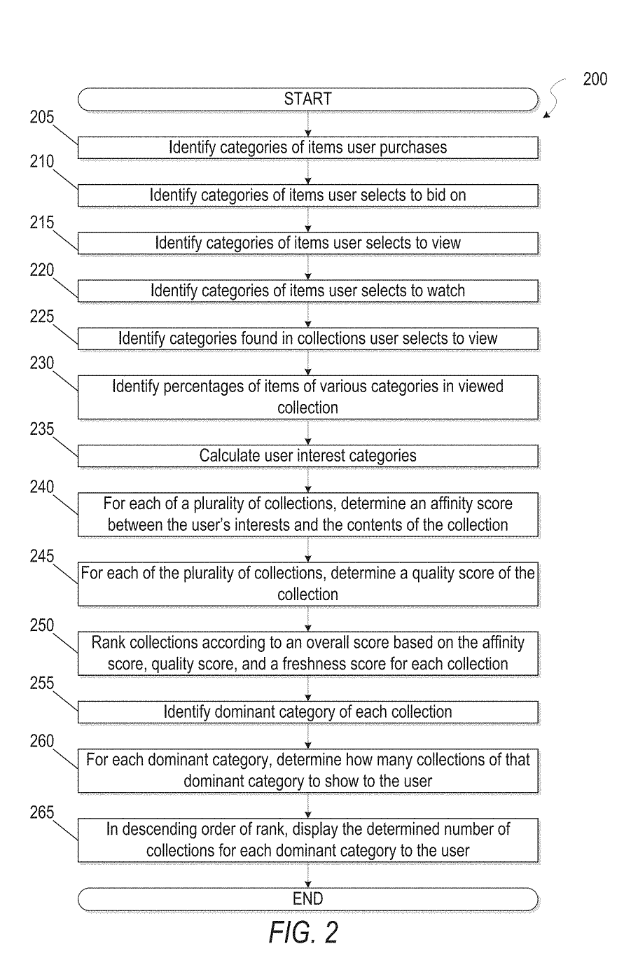

FIG. 2 conceptually illustrates a method 200 of some embodiments for selecting, in real-time, collections of items for sale to present to a user. The method may be applied separately for each user. The illustrated method displays the various operations of the method in a particular order, however one of ordinary skill will understand that the method of some embodiments may be performed with the steps in other orders and may omit certain of the displayed operations. In operations 205-230, the method 200 determines what categories are of interest to a particular user. The categories may include cell phone cases, NFL® apparel, Lego® sets, video games, lamp shades, and the like.

The method 200 identifies (at 205) the categories of items that the user has previously chosen to purchase. These items may include items purchased by various means, including by placing a winning bid or buying with an immediate purchase option. The method then identifies (at 210) the categories of items that the user selects to bid on (i.e., in an online auction). The method then identifies (at 215) the categories of items that the user selects to view. A view of an item may be performed by selecting that item from a list or menu of items (e.g., by clicking on the item). Such a selection may open up a pop-up and/or a new web page with further information about the item such as photographs, item descriptions, and the like. The method then identifies (at 220) the categories of items that the user selects to watch. When an item is selected for watching, the user may receive updates on the status of the item. For example, the user may be notified of price changes, increases of the winning bid amount, impending ends of an auction for the item, and the like.

In some embodiments, the method may also infer an interest in a category of items by a user based on categories of items in collections a user chooses to select for viewing. The method 200 identifies (at 225) categories of items found in collections that the user selects to view and then identifies (at 230) percentages of various categories in viewed collections. The method may infer the user's interests from selection of a category in one or more different ways. The method may infer an interest in each category found in a collection based on the percentage of items in a given category. For example, if the user views a collection in which 50% of the items are Lego sets and 10%, of the items are video games, the method may infer some interest in video games and a stronger interest (e.g., 5 times stronger) in Lego sets based on that user's selection. The method may also infer an interest in the dominant category (e.g., the category of a plurality or majority of the items in that collection), but not in any category with a lower percentage (e.g., an interest in Lego, but not video games in the above example). The method may also infer interests of various strengths for categories in which a threshold percentage of the items are found, but not categories below that threshold. For example, the method may infer an interest only in categories accounting for at least 25% of the items in the collection.

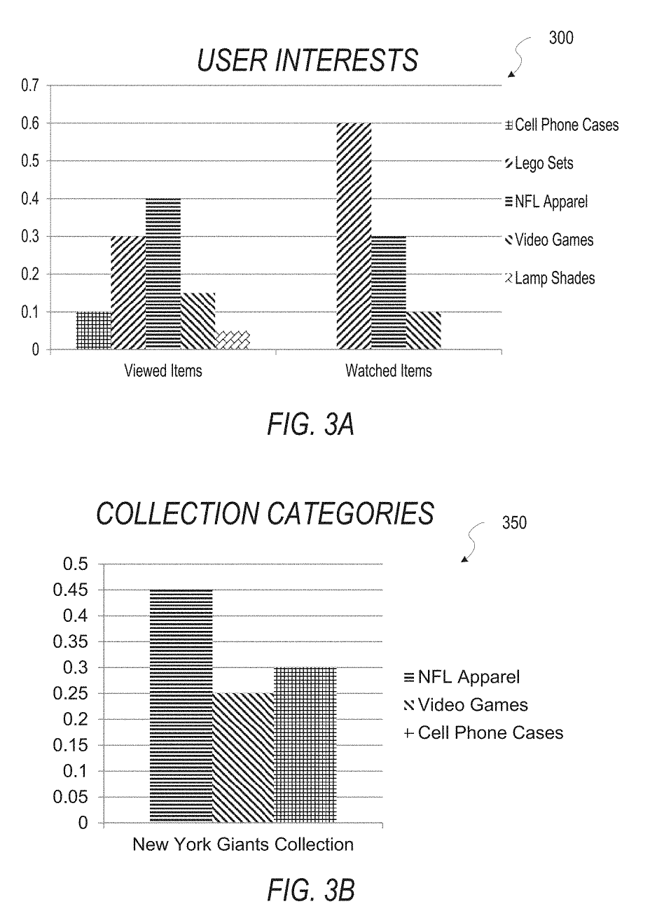

FIG. 3A conceptually illustrates a graph 300 of an example set of different levels of interest by a single user as indicated by categories of viewed items and categories of watched items. In the illustrated example, 10% of the user's views are of cell phone cases, 30% of the user's views are of Lego sets, 40% of the user's views are of NFL apparel, 15% of the user's views are of video games, and 5% of the user's views are of lamp shades. However, the figure illustrates that 60% of the items the user chooses to watch are Lego sets, 30% are NFL apparel, and 10% are video games.

FIG. 3B conceptually illustrates a graph 350 of an example set of different percentages of various categories of items in a particular collection. In the illustrated example, 45% of the items in the collection are items of NFL apparel, 25% of the items in the collection are video games, and 30% of the items in the collection are cell phone cases.

Returning to FIG. 2, after identifying various indicators of interest in particular categories of items, the method 200 calculates (at 235) the user's interest in various categories. The method may calculate these interests as percentages or fractions such as the user having a 60% interest in Lego sets, a 30% interest in NFL apparel, and a 10% interest in video games.

In some embodiments, different actions by the user with respect to various items are weighted differently when determining categories of interest to the user. For example, the method may give increased weight to the categories of items that the user actually bids on or purchases than to items the user merely views without bidding on or purchasing them, more weight to watched items than viewed items, and so on.

The method determines (at 240), for each of a plurality of collections an affinity score between the user's interests and the contents of the collection. The method may represent the percentages of the categories that represent the user's interests as a first vector and the percentages of categories of each collection as a set of vectors. The method may then use a probability divergence function to calculate an asymmetric vector-space distance measure (for each collection) between the vector representing the user's interests and the vector representing the categories of the collection. The method may use a Kullback Leibler divergence, which measures the distance between two empirical distributions to calculate this vector space distance. Eq. (1) is an example of an equation that the method may use to calculate the affinity score.

$${Comp}_{v} ( c ) = {\sum }_{x} c ( x ) log + \frac{c ( x )}{{u}_{v} ( x )} , ∀ x ∈ c \qquad ( 1 )$$

In Eq. (1), c(x) is the fraction of items within the collection that are in category x, uᵥ(x) is the fraction of items in the distribution of (for example) the user's viewed items. The sum is over categories contained in a collection. The method may calculate a separate affinity score for each indicator of a user's interest (e.g., views, watched items, purchased items, and so on). The example Eq. (1) penalizes collections that have items in categories that users did not express interest in. The penalty is the result of the reduction of the fraction of items within the collection, c(x), that match a category that the user is interested in. In the examples shown in FIGS. 3A and 3B, the affinity score based on watched items would increase based on the NFL apparel and video games categories (each found in both watched items and the New York Giants collection). The affinity score based on watched items would decrease because the cell phone cases in the collection reduce the percentage of items in the collection that are in the NFL apparel and video games categories that the user watches.

However, Eq. (1) does not penalize collections that lack any items in some particular category that the user has expressed interest in because the sum is over categories in the collection, not over categories that the user is interested in. Accordingly, in the examples shown in FIGS. 3A and 3B, the affinity score based on watched items would not be decreased based on the lack of Lego sets in the collection.

The method determines (at 245) a quality score for each collection. The method may use any or all of a number of metrics to determine a quality score for a collection. For example, the method may base a quality score on some property of the descriptions of the collections (e.g., whether the collection has a detailed description), the percentage of items in the collection that have notes associated with them, the number of followers a collection has, the number of followers an owner of the collection has (e.g., for owners of multiple collections), whether the collection owner is a paid influencer (i.e., a person paid by the sales site to develop, edit, and/or maintain collections), the percentage of items in the collection with associated images, the average number of images associated with items in the collection, and the like.

The method ranks (at 250) the collections according to an overall score based on the affinity score (or affinity scores), the quality score, and in some embodiments, a freshness score for each collection. The quality scores and affinity scores in some cases would change only when characteristics of the collection changed, or when the user changed interests, respectively. However, a user might log into or visit the sales site multiple times between such changes. In such a case, it may be desirable to present different sets of collections to the user on each login/visit. In order to provide different sets of collections, some embodiments change the freshness scores for each collection on each login or on each visit. The freshness score may be a random number added to the affinity and quality score, or may be determined in some other way. For example, the freshness score for a collection may be increased each time that collection is not presented to a user, and so on.

The method identifies (at 255) a dominant category of each collection. This dominant category may be the category representing the highest percentage of items in the collection. In other embodiments, the dominant category may be the category with items representing the highest total dollar amount in the collection, the category with the highest sales volume over time in the collection, or the like.

The method determines (at 260), for each dominant category, how many collections with that dominant category to display to the user. The method then displays (at 265) the determined number of collections for each dominant category to the user.

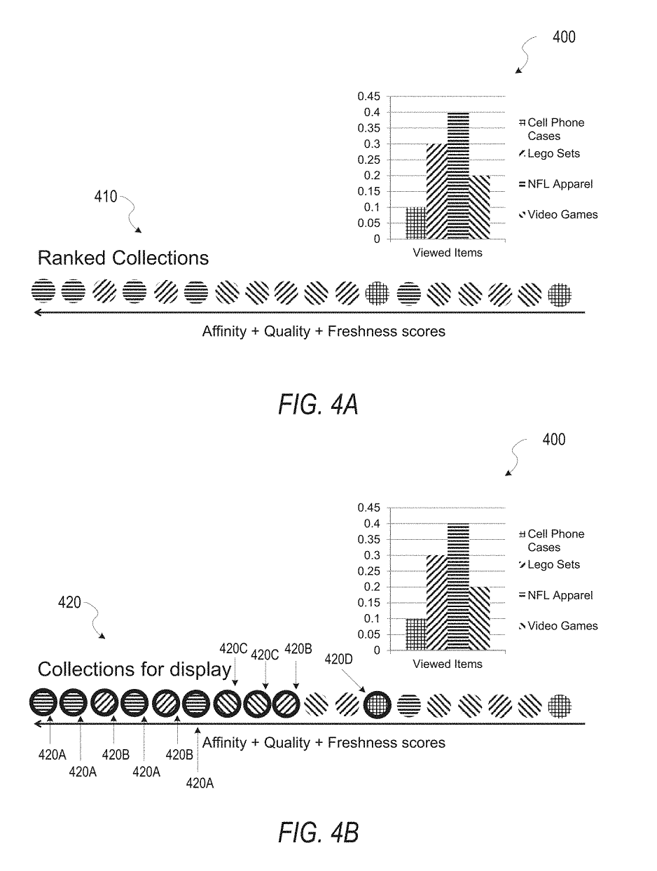

FIG. 4A conceptually illustrates ranking of collections of items with various dominant categories (e.g., operations 250 and 255 of FIG. 2). The figure includes a graph 400 representing categories of viewed items by a particular user and circles 410 each representing a ranked collection of items. The pattern of each circle 410 shows the dominant category of the collection represented by that circle as indicated by the legend of graph 400. This figure only includes collections with dominant categories matching categories of interest to the user (as indicated by graph 400). However, one of ordinary skill in the art will understand that other embodiments may include collections with dominant categories outside the user's interests at this stage.

After ranking the various collections, the method selects collections to display to the user (e.g., operations 260 and 265). FIG. 4B conceptually illustrates the selection of collections for display. The method may select collections based on ranks and proportionate interest of the user. In this figure, the graph 400 shows that the user's most viewed category of items, MFL apparel represents 40% of the views by the user, Lego sets represent 30% of the views, video games represent 20% of the views and cell phone cases represent 10% of the views. For simplicity, this figure assumes that 10 collections will be presented to the user. The method assigns 40% of those 10 collection “slots” (4 slots) to collections where the dominant category is NFL apparel, and so on.

The system therefore selects the 4 highest ranked collections in which the dominant category is NFL apparel. In the figure, these 4 collections are represented by circles 420A. The selection of a collection is conceptually represented by a thick boundary around the circles. Similarly, the system selects the 3 highest ranked collections (represented by circles 420B) with Lego sets as the dominant category, the 2 highest ranked collections with video games as the dominant category (circles 420C), and the highest ranked collection with cell phone cases as the dominant category (circle 420D). As shown in the figure, reserving slots based on the percentage of user interest in a category can result in collections being selected even over higher ranked collections that are not selected. This is intended to improve the variety of displayed collections rather than risking one dominant category taking up all the available display slots for the collections merely because that category happens to be dominant in a large number of highly ranked collections. One of ordinary skill in the art will understand that in cases where the products of the percentages and the number of slots are not integers that methods such as rounding, assigning any extra slots to the highest percentage category, assigning any extra slots to the highest percentage category, or other ways of distributing the fractional slots may be used.

For clarity, the illustrated embodiment of FIGS. 4A-4B shows each collection as having a single dominant category. However, in some embodiments, each collection may be assigned multiple dominant categories. The method may assign as the dominant categories of a collection the categories in the collection representing the N-highest (e.g., highest 3) percentages of items, N-highest total dollar amount in the collection, the category with the highest sales volume over time in the collection, or the like. The method may assign dominant categories based on multiple metrics. For example, the method might assign the category with the highest percentage of items in the collection, the category with the highest total dollar amount in the collection, or the highest sales volume in the collection as dominant categories.

Methods with multiple dominant categories may select collections based on a user's interest in any of the dominant categories in that collection. For example, if the user's category with the highest percent interest is NFL apparel (with 40% interest), then the method will select, for 40% of the available slots, the top ranked sets with NFL apparel as any one of the dominant categories. The method will then go to the user's category with the next highest percent interest, for example, Lego sets at 30%, and select, for the appropriate number of slots (e.g., 30% of the slots), collections with that category as any one of the dominant categories.

When selecting collections based on one user interest, the method may skip collections that have already been selected based on another user interest. Alternatively, the method may select the same collection two or more times based on the user's high interest in multiple categories that are dominant in that collection. Such multiple selections may lead to extra slots being available. For example, if a system allocated 4 slots to category A and 3 slots to category B, but one high ranked collection was selected twice because both category A and category B are dominant categories, then the system will use up only 6 display slots due to the overlap. The method may display that overlapped collection in multiple slots, or assign the slot that would have been used by the second category (if there had been no overlap) to another category. In such a case, the system may move the overlapped collection to a more prominent position, or simply leave the overlapped collection in the same display slot where it would have been displayed absent the overlap.

Although the illustrated example includes selections of collections with dominant categories matching each and every user interest category, the system may have a minimum threshold of interest below which it will not select collections. For example, if the threshold for selecting a dominant category is 5%, then any user categories representing less than a 5% interest level by the user will not be granted any display slots, even if the product of the percentage and the number of available slots is one or more. For example, in a case where there is no threshold, there are 20 slots, and the particular category is 5% of the user's interests, one slot (20×5%=1) would be allocated to a collection with that particular category as the dominant category. However, in an otherwise identical case with a 7% threshold, no slots would be allocated to collections with that particular category as the dominant category.

The method may limit the number of the user's categories to display in other ways instead of using a threshold percentage. For example, the method may select the top N categories of the user's interests (where N is a fixed number such as 2, 3, 4 or the like) and then select collections with each of those N categories as the dominant category of the collection. In cases where the method limits the number of user's categories to be used to select collections for display (with a threshold, numerical limit, or some other criteria) the user's categories that are used may be referred to as the “user's main categories.” For example, if the method uses the top 3 of the user's categories to select collections (with those categories as the dominant categories of the selected collections) then those 3 categories are the user's main categories. Similarly, if the method uses the user's categories, based on those categories being at or above a 20% threshold, to select collections then each category representing at least 20% of the user's interests is one of the user's main categories.

In some cases, a single embodiment may use different ways of limiting the number of the user's main categories. For example, a method may use a threshold limitation when the user's interests include a small number (e.g., 2) of relatively high percentage interests with all other interests far below that level (e.g., two categories with 50% and 45% interest respectively, with the other 5% divided among many categories), but that same method may use a numerical limitation (e.g., 4) when the user is interested in a large number of categories with none of the categories having a high percentage of the user's interest (e.g., the top 4 categories have 4%, 3%, 3%, and 2% of the user's interest).

When the method limits the number of the user's main categories (numerically or by threshold) the method may allocate the available slots for displaying collections proportionately to the interest percentage of each of the user's main categories. For example, if a user's main categories A, B, and C represent 30%, 15%, and 15% of the user's interest, respectively, then collections with dominant category A are allocated ½ of the slots, collections with dominant category B are allocated ¼ of the slots, and collections with dominant category C are allocated ¼ of the slots. Although the above description of the user's main categories describes the user's main categories as being used to determine what dominant categories of collections to select, in some embodiments, the method may use similar or identical limitations on categories to limit what categories of the user's interest are used to calculate affinity scores for a collection. That is, the method of an embodiment may use a limited number of user's categories, a threshold level of interest in user's categories, or all of a user's categories when calculating affinity score.

Independently of how the user's categories used to calculate affinity scores are limited (or not limited) the embodiment might use a limited number of user's categories, a threshold level of interest in user's categories, or all of a user's categories when selecting collections for display. Furthermore, even when a method uses a numerical limit on the user's categories for calculating affinity score and a numerical limit on the user's categories for selecting collections, the numerical limits may be different (e.g., 10 user's categories for calculating affinity but 3 user's categories for selecting collections) or the same. Similarly, a method that uses thresholds to limit user's categories for both affinity score calculation and collection selection may use different thresholds (e.g., 5% for calculating affinity, but 20% for selecting collections) or the same threshold.

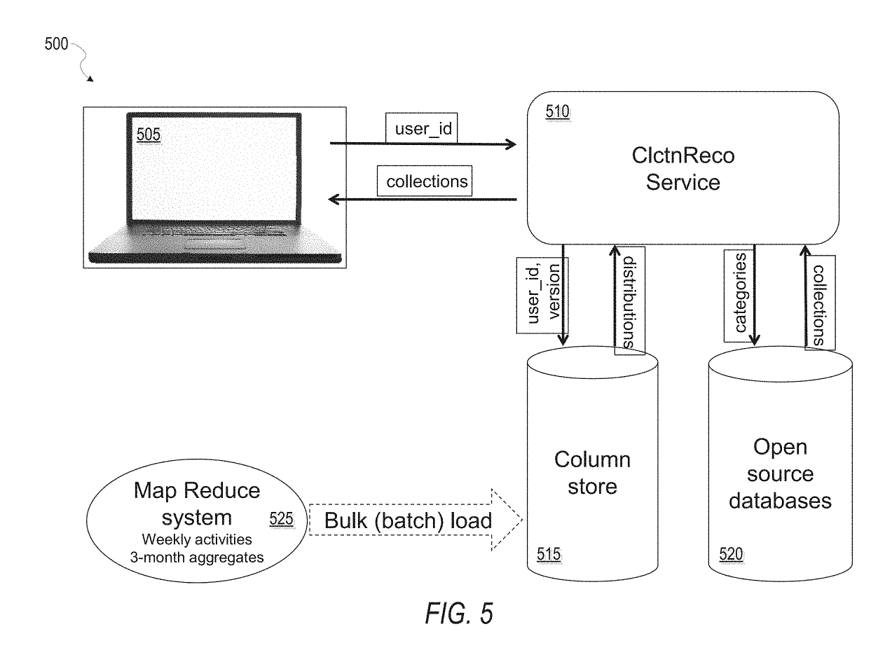

FIG. 5 illustrates the flow of data within an example system 500 for implementing the selection of collections to display to a user. The system includes a user computer 505 which sends a user ID to a collection recommendation service 510. The collection recommendation service may include a raptor service that computes the collection scores. The system may include a column store database 515 (e.g., a Cassandra cluster) to store the user's distributions and a database 520 (e.g., a Solr store for collections). The database may be maintained by a “collections team” on behalf of the sale site. The system may also incorporate a map reduce system 525 (e.g., a Hadoop system) that implements a job that regularly (e.g., weekly) aggregates the user activities. In some cases, the map reduce system may include a second job that merges the regular activities with a longer period of activities (e.g., merges weekly activities with the last 3 months of activities). A third job by the map reduce system 525 may load the aggregate activities into the column store database 515. In summary of FIG. 5: when a request comes in from the user computer 505, the system 500 extracts the user ID from the request header, looks up the category distributions in the column store 515, gets the categories from the distribution, gets a recall set of collections from database 520 whose dominant categories are in the UCD, then the collection recommendation service 510 ranks the collections, selects collections to be displayed to the user, and returns the collections to the user computer 505.

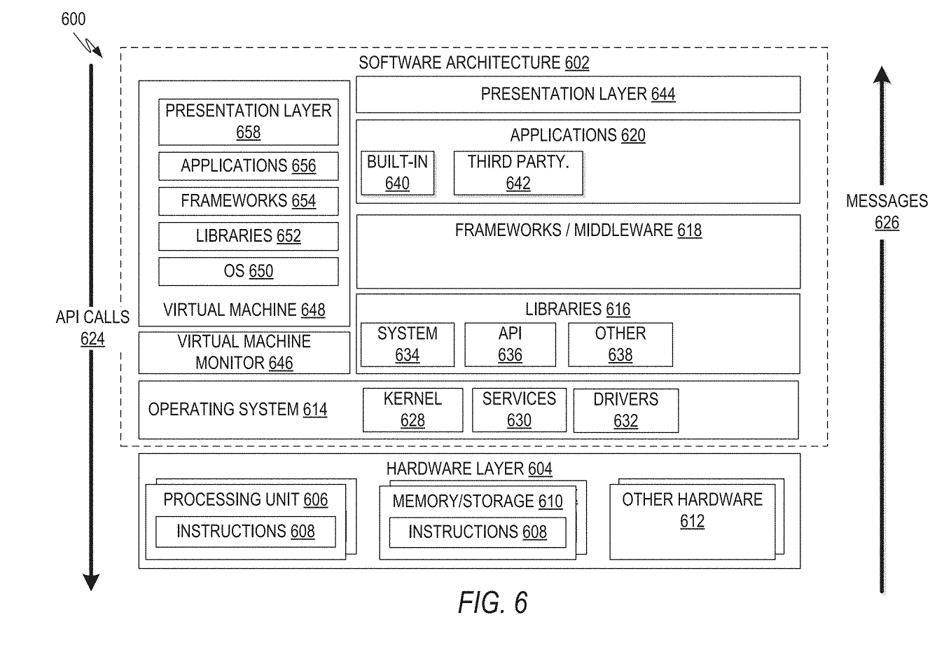

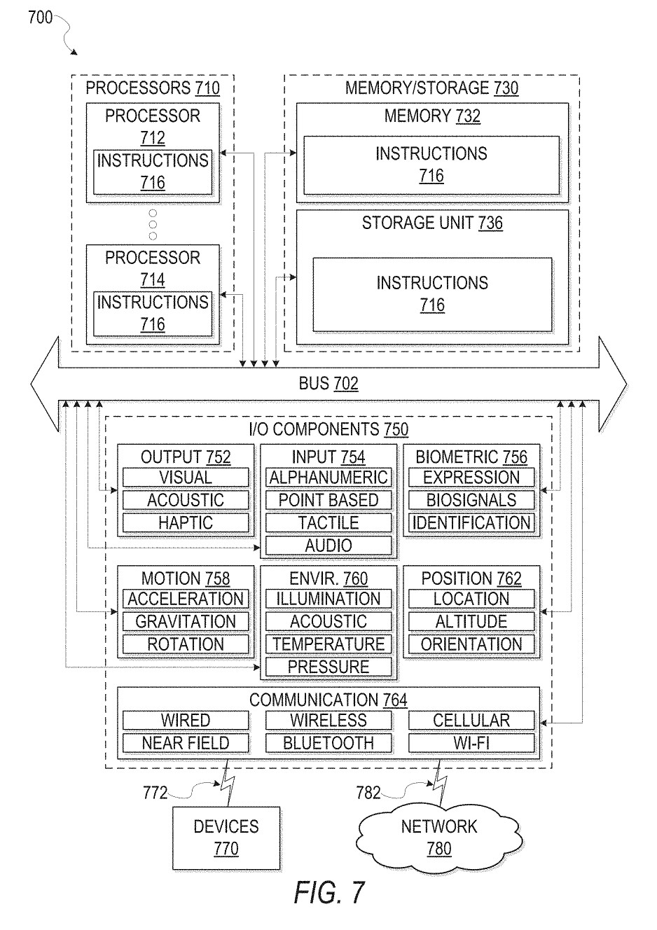

FIG. 6 is a block diagram 600 illustrating a representative software architecture 602, which may be used in conjunction with various hardware architectures herein described. FIG. 6 is merely a non-limiting example of a software architecture and it will be appreciated that many other architectures may be implemented to facilitate the functionality described herein. The software architecture 602 may be executing on hardware such as machine 700 of FIG. 7 that includes, among other things, processors 710, memory 730, and I/O components 750. A representative hardware layer 604 is illustrated and can represent, for example, the machine 700 of FIG. 7. The representative hardware layer 604 comprises one or more processing units 606 having associated executable instructions 608. Executable instructions 608 represent the executable instructions of the software architecture 602, including implementation of the methods, modules and so forth of FIGS. 1-5. Hardware layer 604 also includes memory and/or storage modules 610, which also have executable instructions 608. Hardware layer 604 may also comprise other hardware as indicated by 612 which represents any other hardware of the hardware layer 604, such as the other hardware illustrated as part of machine 700.

In the example architecture of FIG. 6, the software 602 may be conceptualized as a stack of layers where each layer provides particular functionality. For example, the software 602 may include layers such as an operating system 614, libraries 616, frameworks/middleware 618, applications 620 and presentation layer 622. Operationally, the applications 620 and/or other components within the layers may invoke application programming interface (API) calls 624 through the software stack and receive a response, returned values, and so forth illustrated as messages 626 in response to the API calls 624. The layers illustrated are representative in nature and not all software architectures have all layers. For example, some mobile or special purpose operating systems may not provide a frameworks/middleware layer 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings. and so on. The services 630 may provide other common services for the other software layers. The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 616 may provide a common infrastructure that may be utilized by the applications 620 and/or other components and/or layers. The libraries 616 typically provide functionality that allows other software modules to perform tasks in an easier fashion than to interface directly with the underlying operating system 614 functionality (e.g., kernel 628, services 630 and/or drivers 632). The libraries 616 may include system 634 libraries (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks 618 (also sometimes referred to as middleware) may provide a higher-level common infrastructure that may be utilized by the applications 620 and/or other software components/modules. For example, the frameworks 618 may provide various graphic user interface (GUI) functions, high-level resource management, high-level location services, and so forth. The frameworks 618 may provide a broad spectrum of other APIs that may be utilized by the applications 620 and/or other software components/modules, some of which may be specific to a particular operating system or platform.

The applications 620 includes built-in applications 640 and/or third party applications 642. Examples of representative built-in applications 640 may include, but are not limited to, a contacts application, a browser application, a book reader application, a location application, a media application, a messaging application, and/or a game application. Third party applications 642 may include any of the built in applications as well as a broad assortment of other applications. In one specific example, the third party applications may include a database query interface and/or a database tuning assistant. In another specific example, the third party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 642 may invoke the API calls 624 provided by the mobile operating system such as operating system 614 to facilitate functionality described herein.

The applications 620 may utilize built in operating system functions (e.g., kernel 628, services 630 and/or drivers 632), libraries (e.g., system 634, APIs 636, and other libraries 638), frameworks/middleware 618 to create user interfaces to interact with users of the system. Alternatively, or additionally, in some systems interactions with a user may occur through a presentation layer, such as presentation layer 644. In these systems, the application/module “logic” can be separated from the aspects of the application/module that interact with a user.

Some software architectures utilize virtual machines. In the example of FIG. 6, this is illustrated by virtual machine 648. A virtual machine creates a software environment where applications/modules can execute as if they were executing on a hardware machine (such as the machine of FIG. 7, for example). A virtual machine is hosted by a host operating system (operating system 614 in FIG. 7) and typically, although not always, has a virtual machine monitor 646, which manages the operation of the virtual machine as well as the interface with the host operating system (i.e., operating system 614). A software architecture executes within the virtual machine such as an operating system 650, libraries 652, frameworks/middleware 654, applications 656 and/or presentation layer 658. These layers of software architecture executing within the virtual machine 648 can be the same as corresponding layers previously described or may be different.

### Example Machine Architecture and Machine-Readable Medium

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example the instructions may cause the machine to execute the flow diagrams of FIG. 6, and so forth. The instructions transform the general, non-programmed machine into a particular machine programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by machine 700. The ranking systems described with respect to FIGS. 2-5 may be implemented on one or more servers with only the display of the results being implemented on a client device. Alternately the scoring system may collect data using servers but analyze that data on a client device and display the results on the client device. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 712 and processor 714 that may execute instructions 716. The term “processor” is intended to include multi-core processor that may comprise two or more independent processors (sometimes referred to as “cores”) that may execute instructions contemporaneously. Although FIG. 7 shows multiple processors, the machine 700 may include a single processor with a single core, a single processor with multiple cores (e.g., a multi-core process), multiple processors with a single core, multiple processors with multiples cores, or any combination thereof.

The memory/storage 730 may include a memory 732, such as a main memory, or other memory storage, and a storage unit 736, both accessible to the processors 710 such as via the bus 702. The storage unit 736 and memory 732 store the instructions 716 embodying any one or more of the methodologies or functions described herein. The instructions 716 may also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of processors 710 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762 among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via coupling 782 and coupling 772 respectively. For example, the communication components 764 may include a network interface component or other suitable device to interface with the network 780. In further examples, communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a Universal Serial Bus (USB)).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as, location via Internet Protocol (IP) geo-location, location via Wi-Fi® signal triangulation, location via detecting a NFC beacon signal that may indicate a particular location, and so forth.

In various example embodiments, one or more portions of the network 780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or other type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., hypertext transfer protocol (HTTP)). Similarly, the instructions 716 may be transmitted or received using a transmission medium via the coupling 772 (e.g., a peer-to-peer coupling) to devices 770. The term “transmission medium” shall be taken to include any intangible medium that is capable of storing, encoding, or carrying instructions 716 for execution by the machine 700, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
identifying categories of items that interest a user by analyzing the user's interaction with an online shopping site;
for each of a plurality of pre-defined collections of items for sale on the online shopping site:
identifying categories of items for sale in the pre-defined collection of items for sale; and
based on categories of items that both interest the user and are in the pre-defined collection of items for sale, determining an affinity score between the pre-defined collection of items for sale and the user's interests;
based at least partly on the affinity scores of the pre-defined collections of items for sale, selecting, in real-time, a subset of the plurality of pre-defined collections of items for sale to display to the user; and
displaying the selected subset of pre-defined collections of items for sale to the user.

2. The method of claim 1, wherein identifying categories of items for sale in the pre-defined collection of items for sale comprises identifying, for each category of items in the pre-defined collection of items for sale a percentage of items within the collection that are within the category of items.

3. The method of claim 2, wherein identifying categories of items that interest a user by analyzing the user's interaction with an online shopping site comprises, for each category of items of interest to the user, identifying a percentage of views by the user of items that are within the category of items.

4. The method of claim 3 further comprising, for each of the plurality of pre-defined collections of items for sale, identifying one or more dominant categories of items in the pre-defined collection.

5. The method of claim 4 further comprising, for each pre-defined collections of items for sale, determining a quality score for the collection, wherein the selected subset of the plurality of pre-defined collections of items for sale to display to the user is further based on the quality score.

6. The method of claim 5, wherein the selecting, in real-time, of the subset of the plurality of pre-defined collections of items for sale to display to the user comprises:
identifying a total number of collections of items for sale to display to the user;
for each of a plurality of categories of items of interest to the user:
selecting a portion of the total number of collections of items for sale to display to the user based on the percentage of the user's views in that category; and
selecting pre-defined collections of items for sale to display to the user based on at least the affinity score, the quality score, and the selected portion.

7. The method of claim 6, wherein the selecting of the pre-defined collections of items for sale to display to the user is further based on, for each collection, at least a random value for the collection added to the quality and affinity scores of the collection.

8. A system including at least one electronic computing device that implements an online shopping site, wherein the electronic device comprises at least one processing unit and a non-transitory machine readable medium, the electronic computing device communicatively connected to a user device over a network, the machine readable medium storing sets of instructions which when executed by the at least one processing unit cause the electronic computing device to:
identify categories of items that interest a user by analyzing the user's interaction with the online shopping site;
for each of a plurality of pre-defined collections of items for sale on the online shopping site:
identify categories of items for sale in the pre-defined collection of items for sale; and
based on categories of items that both interest the user and are in the pre-defined collection of items for sale, determine an affinity score between the pre-defined collection of items for sale and the user's interests;
based at least partly on the affinity scores of the pre-defined collections of items for sale, select, in real-time, a subset of the plurality of pre-defined collections of items for sale to display to the user; and
command the user device to display, on the user device, the selected subset of pre-defined collections of items for sale to the user.

9. The system of claim 8, wherein identifying categories of items for sale in the pre-defined collection of items for sale comprises identifying, for each category of items in the pre-defined collection of items for sale a percentage of items within the collection that are within the category of items.

10. The system of claim 9, wherein identifying categories of items that interest a user by analyzing the user's interaction with an online shopping site comprises, for each category of items of interest to the user, identifying a percentage of views by the user of items that are within the category of items.

11. The system of claim 10, wherein the non-transitory machine readable medium further stores sets of instructions which when executed by at least one processing unit cause the electronic computing device to, for each of the plurality of pre-defined collections of items for sale, identify one or more dominant categories of items in the pre-defined collection.

12. The system of claim 11, wherein the non-transitory machine readable medium further stores sets of instructions which when executed by at least one processing unit cause the electronic computing device to, for each pre-defined collections of items for sale, determine a quality score for the collection, wherein the selected subset of the plurality of pre-defined collections of items for sale to display to the user is further based on the quality score.

13. The system of claim 12, wherein the selecting, in real-time, of the subset of the plurality of pre-defined collections of items for sale to display to the user comprises:
identifying a total number of collections of items for sale to display to the user;
for each of a plurality of categories of items of interest to the user:
selecting a portion of the total number of collections of items for sale to display to the user based on the percentage of the user's views in that category; and
selecting pre-defined collections of items for sale to display to the user based on at least the affinity score, the quality score, and the selected portion.

14. The system of claim 13, wherein the selecting of the pre-defined collections of items for sale to display to the user is further based on, for each collection, at least a random value for the collection added to the quality and affinity scores of the collection.

15. A non-transitory machine readable medium storing sets of instructions, which when executed by at least one processing unit:
identify categories of items that interest a user by analyzing the user's interaction with an online shopping site;
for each of a plurality of pre-defined collections of items for sale on the online shopping site:
identify categories of items for sale in the pre-defined collection of items for sale; and
based on categories of items that both interest the user and are in the pre-defined collection of items for sale, determine an affinity score between the pre-defined collection of items for sale and the user's interests;
based at least partly on the affinity scores of the pre-defined collections of items for sale, select, in real-time, a subset of the plurality of pre-defined collections of items for sale to display to the user; and
display the selected subset of pre-defined collections of items for sale to the user.

16. The non-transitory machine readable medium of claim 15, wherein identifying categories of items for sale in the pre-defined collection of items for sale comprises identifying, for each category of items in the pre-defined collection of items for sale a percentage of items within the collection that are within the category of items.

17. The non-transitory machine readable medium of claim 16, wherein identifying categories of items that interest a user by analyzing the user's interaction with an online shopping site comprises, for each category of items of interest to the user, identifying a percentage of views by the user of items that are within the category of items.

18. The non-transitory machine readable medium of claim 17, wherein the non-transitory machine readable medium further store sets of instructions which when executed by at least one processing unit, for each of the plurality of pre-defined collections of items for sale, identify one or more dominant categories of items in the pre-defined collection.

19. The non-transitory machine readable medium of claim 18, wherein the non-transitory machine readable medium further store sets of instructions which when executed by at least one processing unit, for each pre-defined collections of items for sale, determine a quality score for the collection, wherein the selected subset of the plurality of pre-defined collections of items for sale to display to the user is further based on the quality score.

20. The non-transitory machine readable medium of claim 19, wherein the selecting, in real-time, of the subset of the plurality of pre-defined collections of items for sale to display to the user comprises:
identifying a total number of collections of items for sale to display to the user;
for each of a plurality of categories of items of interest to the user:
selecting a portion of the total number of collections of items for sale to display to the user based on the percentage of the user's views in that category; and
selecting pre-defined collections of items for sale to display to the user based on at least the affinity score, the quality score, and the selected portion.
